(19) United States
(12) Patent Application Publication
(10) Pub. No.: US 2021/0072002 A1
(43) Pub. Date: Mar. 11, 2021

(54) Live-Fire Training System

(71) Applicant: Daniel Yockey, Phoenix, AZ (US)

(72) Inventor: Daniel Yockey, Phoenix, AZ (US)

(21) Appl. No.: 17/016,302

(22) Filed: Sep. 9, 2020

Related U.S. Application Data
(60) Provisional application No. 62/897,862, filed on Sep. 9, 2019.

(51) Int. Cl. F41J 5/056; H04W 88/02; G08B 5/36; G06F 1/26

(52) U.S. Cl. CPC F41J 5/056; G06F 1/266; G08B 5/36; H04W 88/02

(57) ABSTRACT

A live-fire training system enables users to setup customizable tactical scenarios in multiple-threat and judgmental exercises. The live-fire training system includes at least one remote management unit and a plurality of target-attachment units. The at least one remote management unit synchronizes with each of the plurality of target-attachment units in order to control and manage each of the plurality of target-attachment units. Further, the at least one remote management unit communicates with an external computing device of a user in order to process commands inputted by the user. Each of the plurality of target-attachment units is mounted onto a metal target in order gather hit-detection data and to visually distinguish specific targets amongst a plurality of metal targets.

The current application claims a priority to the U.S. Provisional Patent application Ser. No. 62/897,862 filed on Sep. 9, 2019.

### FIELD OF THE INVENTION

The present invention generally relates to firearm training. More specifically, the present invention provides a live-fire training system which enables users to setup customizable tactical scenarios in multiple-threat and judgmental exercises.

### BACKGROUND OF THE INVENTION

An objective of the present invention is to provide a live-fire training system that can be used with existing steel targets. The present invention, preferably referred to as TAC-Hub system, takes marksmanship fundamentals to the next level. The TAC-Hub system was created to correct bad neural pathways that are developed by using a shot timer and static targets. The TAC-Hub system forces users to use visual cues and correct bad shooting habits such as shooting with one eye closed, not scanning for other targets or threats, etc.

The TAC-Hub system can be utilized in multiple-threat and judgmental exercises by enabling customizable tactical scenarios as well as head to head competition. The TAC-Hub system can be attached to the back of any steel target and delivers real time data to a mobile computing device. Games and application modes are controlled by a TAC-Hub mobile application to insure quick and intuitive training. In addition, the TAC-Hub system provides a light-emitting diode (LED) system which gives visual feedback and can be configured for close range shooting or distance shooting. The LED system can also be swapped out for infrared (IR) illuminators to be used as a night vision trainer.

In a preferred embodiment, the TAC-Hub system comprises a plurality of target-attachment units with preferred dimensions of 5 inches in height, 4 inches in width, and 2 inches in thickness. Each of the plurality of target-attachment units can be attached to any metal target. The TAC-Hub system comprises a battery life of 12 to 24 hours of shooting time with rechargeable capabilities. The TAC-Hub system utilizes up to four replaceable red-green-blue light-emitting diodes (RGB LEDs) or infrared light-emitting diodes (IR LEDs) for night vision training. Further, the TAC-Hub system can synchronize up to 100 target-attachment units with a range of over 1,000 yards. The TAC-Hub system further comprises at least one remote management unit which connects the TAC-Hub system to a portable computing device. The portable computing device preferably connects to the at least one remote management unit via a personal-area wireless module. The at least one remote management unit sends and receives data from each of the plurality of target-attachment units via a LoRaWAN wireless module. The at least one remote management unit converts the data from each of the plurality of target-attachment units to wireless signals and sends the results back to the portable computing device. A mobile application is also provided which can be installed on the portable computing device to give users mode options, record times, and give feedback.

### BRIEF DESCRIPTION OF THE DRAWINGS

FIG. 1 is a schematic diagram illustrating the overall system of the present invention.

FIG. 2 is a schematic diagram illustrating how the at least one remote management unit manages each of the plurality of target-attachment units.

FIG. 3 is a schematic diagram illustrating how the at least one remote management unit communicates with a portable computing device.

FIG. 4 is a schematic diagram illustrating the electronic and electrical connections of the at least one remote management unit.

FIG. 5 is a schematic diagram illustrating the electronic and electrical connections of a single target-attachment unit.

FIG. 6 is a rear perspective view of the attachment housing displaying the unit-attaching mechanism.

FIG. 7 is an exploded rear perspective view of the attachment housing displaying the plurality of magnets and the plurality of magnet cavities.

FIG. 8 is a schematic diagram illustrating the electronic connections of the plurality of electronic ports and the plurality of notification lights.

### DETAIL DESCRIPTIONS OF THE INVENTION

All illustrations of the drawings are for the purpose of describing selected versions of the present invention and are not intended to limit the scope of the present invention.

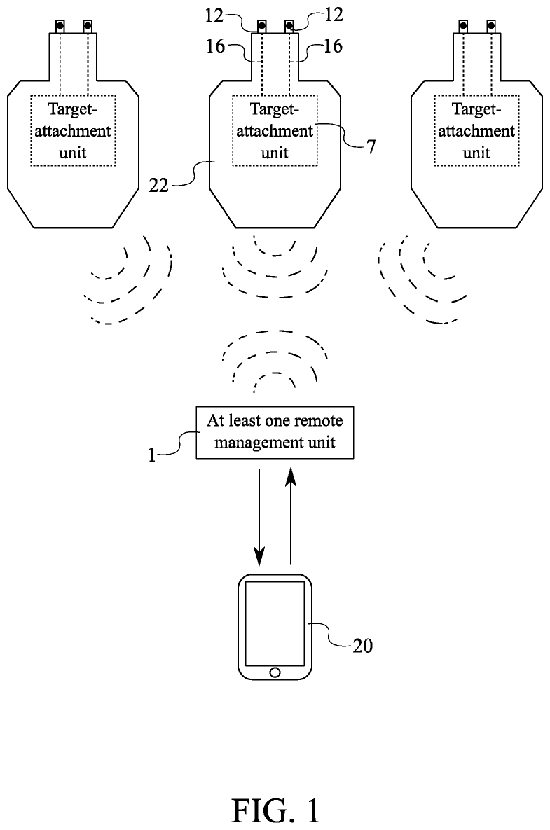

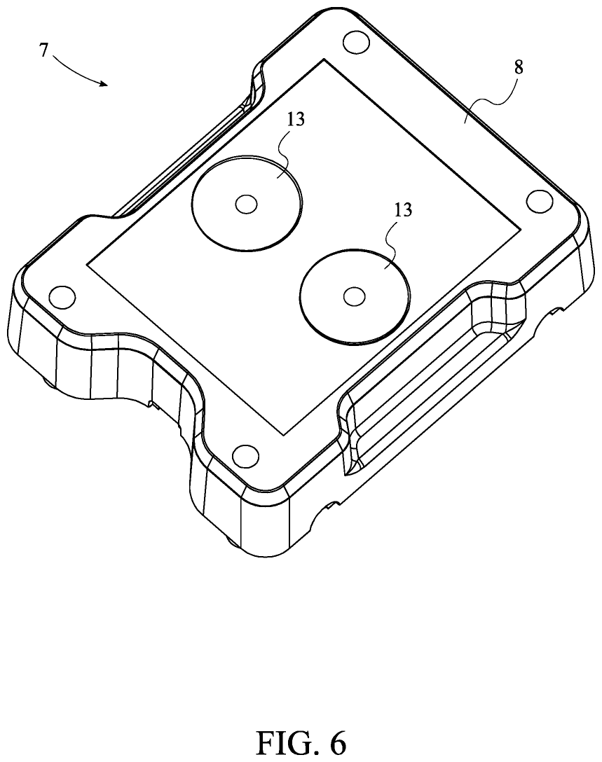

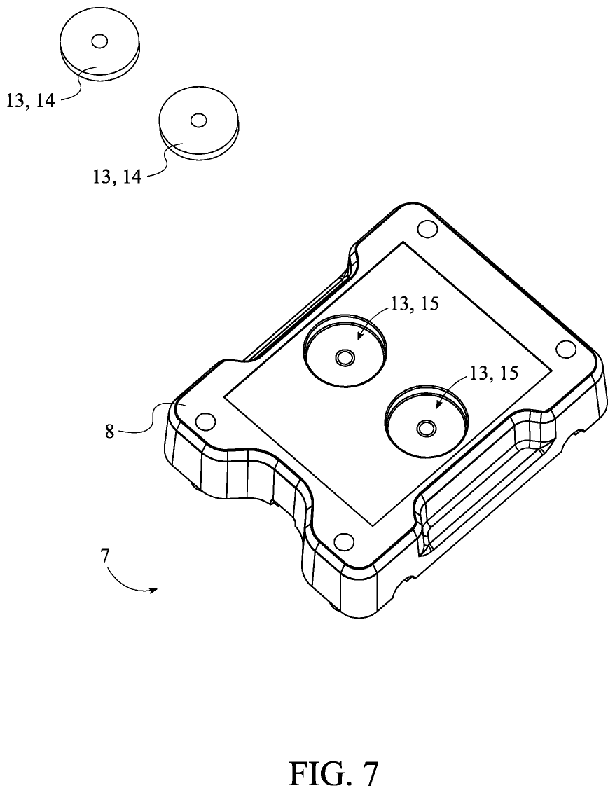

In reference to FIGS. 1 through 8, the present invention is a live-fire training system which enables users to setup customizable tactical scenarios in multiple-threat and judgmental exercises. A preferred embodiment of the present invention comprises at least one remote management unit 1 and a plurality of target-attachment units 7. The at least one remote management unit 1 synchronizes with each of the plurality of target-attachment units 7 in order to control and manage each of the plurality of target-attachment units 7. Further, the at least one remote management unit 1 communicates with an external computing device of a user in order to process commands inputted by the user. Each of the plurality of target-attachment units 7 is mounted onto a metal target 22 in order gather hit-detection data and to visually distinguish specific targets amongst a plurality of metal targets 22.

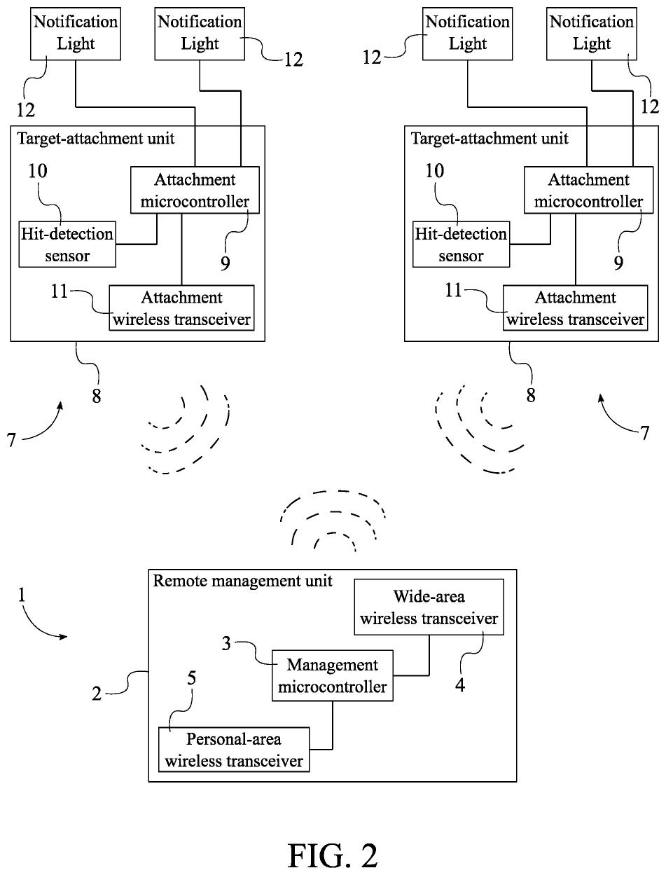

The general configuration of the aforementioned components enables users to setup customizable tactical scenarios in multiple threat and judgmental exercises through use of the present invention. With reference to FIGS. 1 and 2, the at least one remote management unit 1 comprises a management housing 2, a management microcontroller 3, a wide-area wireless transceiver 4, and a personal-area wireless transceiver 5. The management housing 2 protects and conceals the electronic components of the at least one remote management unit 1. The management microcontroller 3 manages and controls the wide-area wireless transceiver 4 and the personal-area wireless transceiver 5. The wide-area wireless transceiver 4 allows the at least one remote management unit 1 to synchronize with and mange each of the plurality of target-attachment units 7. The personal-area wireless transceiver 5 allows for communication with an external computing device of a user. Each of the plurality of target-attachment units 7 comprises an attachment housing 8, an attachment microcontroller 9, at least one hit-detection sensor 10, an attachment wireless transceiver 11, and a plurality of notification lights 12. The attachment housing 8 protects and conceals the electronic components of its corresponding target-attachment unit. The attachment microcontroller 9 manages and controls the at least one hit-detection sensor 10, the attachment wireless transceiver 11, and the plurality of notification lights 12. The at least one hit-detection sensor 10 captures motion data when a metal target 22, on which a target-attachment unit is mounted, is shot by a user's firearm. The attachment wireless transceiver 11 allows communication between each of the plurality of target-attachment units 7 and the at least one remote management unit 1. The plurality of notification lights 12 provides visual indicators of which metal target 22, on which a target-attachment unit is mounted, a user should focus and/or when a user should shoot the metal target 22.

With reference to FIG. 2, the management microcontroller 3, the wide-area wireless transceiver 4, and the personal-area wireless transceiver 5 are mounted within the management housing 2. In further detail, a printed circuit board (PCB) assembly may be mounted within the management housing 2, and the management microcontroller 3, the wide-area wireless transceiver 4, and the personal-area transceiver are electrically integrated into the PCB assembly. This arrangement allows the management housing 2 to protect and conceal the electronic components of the at least one remote management unit 1. Moreover, the management microcontroller 3 is electronically connected to the wide-area wireless transceiver 4 and the personal-area wireless transceiver 5. Thus, the management microcontroller 3 can manage and communicate with the wide-area wireless transceiver 4 and the personal-area wireless transceiver 5.

Similar to the management housing 2 with reference to FIG. 2, the attachment microcontroller 9, the at least one hit-detection sensor 10, and the attachment wireless transceiver 11 are mounted within the attachment housing 8. In further detail, another PCB assembly may be mounted within the attachment housing 8, and the attachment microcontroller 9, the at least one hit-detection sensor 10, and the attachment wireless transceiver 11 are electrically integrated into the other PCB assembly. The plurality of notification lights 12 is externally mounted to the attachment housing 8. This arrangement allows each of the plurality of notification lights 12 to be mounted near the perimeter of a metal target 22 in order to allow a user to clearly see each of the plurality of notification lights 12 when using the present invention. Further, the attachment microcontroller 9 is electronically connected to the at least one hit-detection sensor 10, the attachment wireless transceiver 11, and the plurality of notification lights 12. Thus, the attachment microcontroller 9 can manage and communicate with the at least one hit-detection sensor 10, the attachment wireless transceiver 11, and the plurality of notification lights 12. Moreover, the wide-area wireless transceiver 4 is communicably coupled to the attachment wireless transceiver 11 for each of the plurality of target-attachment units 7. This arrangement allows the at least one remote management unit 1 to synchronize with and manage each of the plurality of target-attachment units 7.

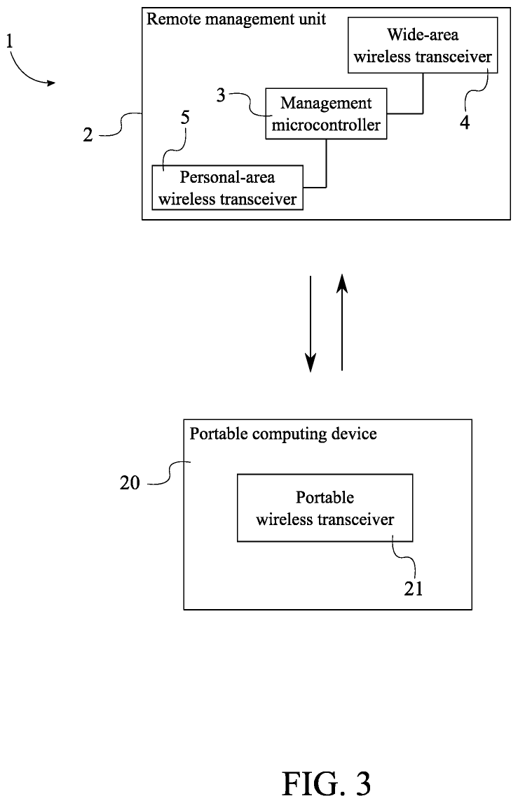

As mentioned previously and with reference to FIG. 3, the personal-area wireless transceiver 5 allows the at least one remote management unit 1 allows for communication with a computing device of a user. The computing device of a user is preferably at least one portable computing device 20 such as, but not limited to, a smartphone device or a mobile tablet device. The at least one portable computing device 20 comprises a portable wireless transceiver 21. The portable wireless transceiver 21 allows communication between the at least one portable computing device 20 and an external device that is inside of the same personal area network as the at least one portable computing device 20. Thus, the personal-area wireless transceiver 5 is communicably coupled to the portable wireless transceiver 21. This allows two-way communication between the at least one remote management unit 1 and the at least one portable computing device 20.

In order to effectively mount each of the plurality of target-attachment units 7 onto a metal target 22 and with reference to FIGS. 1, 6, and 7, each of the plurality of target-attachment units 7 may further comprise a unit-attaching mechanism 13. The unit-attaching mechanism 13 is externally mounted into the attachment housing 8. This arrangement positions the unit-attaching mechanism 13 in order to easily allow a user to mount each of the plurality of target-attachment units 7 to a metal target 22. The unit-attaching mechanism 13 may be any means able to mount a target-attachment unit onto a metal target 22. In the preferred embodiment, the unit-attaching mechanism 13 comprises a plurality of magnets 14 and a plurality of magnet cavities 15. The plurality of magnet cavities 15 traverses into the attachment housing 8. In further detail, the plurality of magnets 14 cavities is a set of pockets, integrated into the attachment housing 8, designed to receive the plurality of magnets 14. Each of the plurality of magnets 14 is mounted into a corresponding cavity from the plurality of magnet cavities 15 which allows the plurality of magnet cavities 15 to securely hold the plurality of magnets 14 in place on the attachment housing 8. In further detail, the fastener such as a screw is used to mount each of the plurality of magnets 14 into the corresponding cavity.

In order for the at least one remote management unit 1 to effectively communicate with each of the plurality of target-attachment units 7 at long ranges, the attachment wireless transceiver 11 is preferably a long range wide area network (LoRaWAN) module, and the wide-area wireless transceiver 4 is preferably a LoRaWAN module. This allows the at least one remote management unit 1 to synchronize with and manage each of the plurality of target-attachment units 7 at ranges over 1000 yards.

As mentioned previously, the at least one hit-detection sensor 10 captures motion data. The at least one hit-detection sensor 10 may be any type of sensor able to detect motion such as, but not limited to, vibrations. In the preferred embodiment, the at least one detection sensor is preferably an accelerometer. The accelerometer is a sensor able to measure acceleration. In further detail, when a metal target 22, on which a target-attachment unit is mounted, is struck by bullet fired from a firearm, the metal target 22 vibrates, which is measured as vibration data by the accelerometer. This vibration data, indicating that a metal target 22 has been hit, is gathered, and relayed from the at least one hit-detection sensor 10, through the attachment microcontroller 9, through the management microcontroller 3, and to the at least one portable computing device 20.

In order to effectively indicate which metal target 22 should be shot at and/or when a metal target 22 should be shot at, each of the plurality of notification lights 12 is preferably a red-green-blue light emitting diode (RGB LED) module. The RGB LED module allows for the use of multiple colors in order to visually indicate metal targets 22, on which a target-attachment unit is mounted. Alternatively and if a user wishes to use the present invention to practice or engage in nighttime shooting, each of the plurality of notification lights 12 is preferably an infrared light emitting diode (IR LED) module. The IR LED can be seen when wearing a pair of night-vision goggles. Thus, a user can practice or engage in nighttime shooting through use of the present invention.

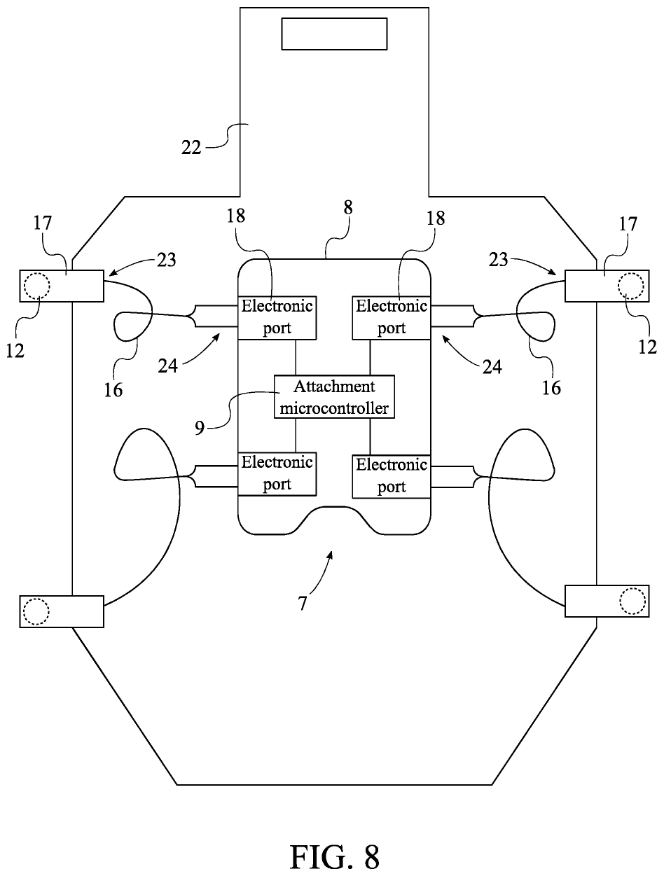

In order to allow the plurality of notification lights 12 to be mounted onto a metal target 22 while offset from the attachment housing 8 and with reference to FIG. 8, each of the plurality of target-attachment units 7 may further comprise a plurality of light cables 16 and a plurality of light-attaching mechanisms 17. Each of the plurality of notification lights 12 is electrically connected to the attachment microcontroller 9 by a corresponding cable from the plurality of light cables 16. Thus, the attachment microcontroller 9 can manage each of the plurality of notification lights 12 through the corresponding cable. Further, each of the plurality of light-attaching mechanisms 17 is externally mounted into a corresponding light from the plurality of notification lights 12. The plurality of light-attaching mechanisms 17 may be any means able to mount each of the plurality of notification lights 12 onto a metal target 22. In the preferred embodiment, the plurality of light-attaching mechanisms 17 is a hook-and-loop fastener. Thus, each of the plurality of notification lights 12 can be mounted onto a metal target 22 while offset from the attachment housing 8.

In order to effectively establish the electronic connection between the plurality of notification lights 12 and the attachment microcontroller 9 and with reference to FIG. 8, each of the plurality of target-attachment units 7 may further comprise a plurality of electronic ports 18. Each of the plurality of light cables 16 comprises a distal cable end 23 and a proximal cable end 24. Each of the plurality of notification lights 12 is electronically connected to the distal cable end 23 of the corresponding cable. Thus, each of the plurality of notification lights 12 is permanently secured to the corresponding cable, and electrical signals can flow from the corresponding cable to each of the plurality of notification lights 12. The plurality of electronic ports 18 is integrated into the attachment housing 8 and is distributed about the attachment housing 8. In further detail, the plurality of electronic ports 18 traverses into the attachment housing 8 and are designed to receive a cable from the plurality of light cables 16. Further, there may be at least one electronic port at each lateral surface of the attachment housing 8 in order to allow each of the plurality of notification lights 12 to be mounted at multiple locations on a metal target 22. Moreover, the plurality of electronic ports 18 is electrically connected to the attachment microcontroller 9. This allows electrical signals to flow from the attachment microcontroller 9 to each of the plurality of electronic ports 18. The proximal cable end 24 for each of the plurality of light cables 16 is electronically engaged to a corresponding port from the plurality of electronic ports 18. Thus, this arrangement effectively establishes the electronic connection between each of the plurality of notification lights 12 and the attachment microcontroller 9.

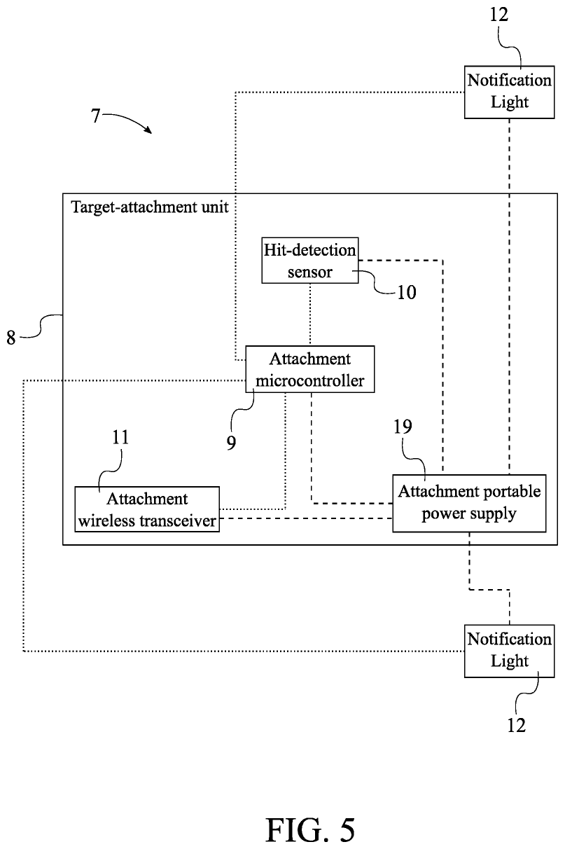

In order to electrically power the electronic components of a target-attachment unit and with reference to FIG. 5, each of the plurality of target-attachment units 7 may further comprise an attachment portable power supply 19. The attachment portable power supply 19 is preferably a set of rechargeable batteries. The attachment portable power supply 19 is mounted within the attachment housing 8. In further detail, a battery retainer is mounted within the attachment housing 8, and the attachment portable power supply 19 is electrically situated within the battery retainer. The attachment portable power supply 19 is electrically connected to the attachment microcontroller 9, the at least one hit-detection sensor 10, the attachment wireless transceiver 11, and each of the plurality of notification lights 12. Thus, electrical power is provided to the electronic components of each of the plurality of target-attachment units 7.

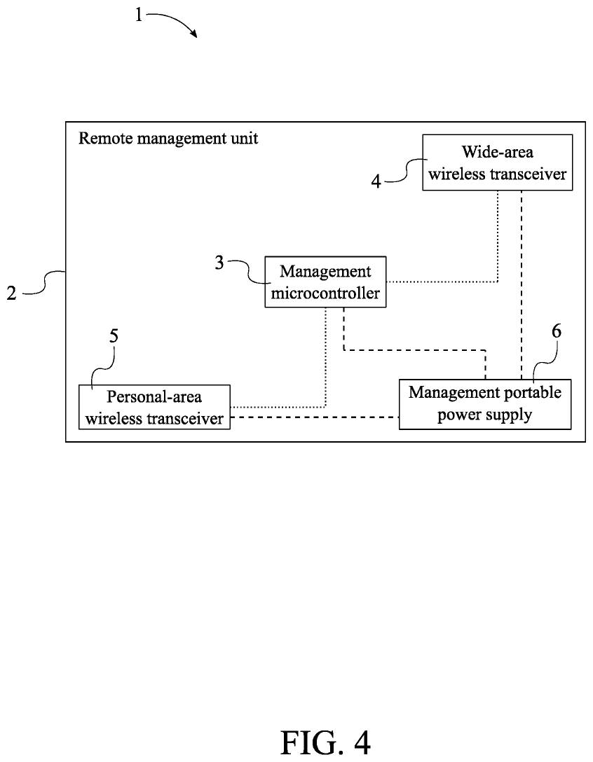

Similarly and in order to electrically power the electronic components of the at least one remote management unit 1 and with reference to FIG. 4, the at least one remote management unit 1 may further comprise a management portable power supply 6. The management portable power supply 6 is preferably a set of rechargeable batteries. The management portable power supply 6 is mounted within the management housing 2. In further detail, another battery retainer is mounted within the management housing 2 and the management portable power supply 6 is electrically situated within the other battery retainer. The management portable power supply 6 is electrically connected to management microcontroller 3, the wide-area wireless transceiver 4, and the personal-area wireless transceiver 5. Thus, electrical power is provided to the electronic components of the at least one remote management unit 1.

The present invention enables remote operation of each of the plurality of target-attachment units 7 through a mobile application that can be access using the at least one portable computing device 20. The mobile application enables a user to customize the mode of operation of the plurality of target-attachment units 7 so the user can practice various skills. The mobile application facilitates communication between the portable computing device and the at least one remote management unit 1. The different modes in the mobile application are completely customizable to the end user, such as customizing multiple hit functions, RGB LED color change for red/green color blind, etc. Custom functions in the mobile application can be created for end users as well to accommodate the individual user's specific training needs. Some of the modes of the present invention can include a shoot-no shoot mode, a versus mode, a course mode, and a long-range mode. The shoot-no shoot mode enables the user to run shoot-no shoot drills which are different and randomized each time that the user runs the mode. The mobile application provides user feedback including reaction time to first target and total completion time. The versus mode involves the user shooting head-to-head to try and claim more hits than an opponent. The multiple training units can randomly switch between red and green for a length of time that the user specifies when starting this exercise in the mobile application. The mobile application provides user feedback including the total number of hits for each shooter. The course mode enables the user to set up a course of fire and will record number of hits as well as total completion time. Finally, the long-range mode is preferably the default mode for the present invention. The user can set the time for the plurality of notification lights 12 to stay on after a hit is registered. As more functions are created, the user will receive a notice in the mobile application of an update. The user can choose to update the software to receive all new functions and the data will be transmitted to all target units. Furthermore, the present invention can provide an online platform to enable the growth of an online community where users can connect with each other to share how users utilize the present invention or share drill times or training progression. The mobile application can be connected to the online platform.

Although the invention has been explained in relation to its preferred embodiment, it is to be understood that many other possible modifications and variations can be made without departing from the spirit and scope of the invention as hereinafter claimed.

What is claimed is:

1. A live-fire training system comprises:
at least one remote management unit;
a plurality of target-attachment units;
the at least one remote management unit comprises a management housing, a management microcontroller, a wide-area wireless transceiver, and a personal-area wireless transceiver;
each of the plurality of target-attachment units comprises an attachment housing, an attachment microcontroller, at least one hit-detection sensor, an attachment wireless transceiver, and a plurality of notification lights;
the management microcontroller, the wide-area wireless transceiver, and the personal-area wireless transceiver being mounted within the management housing;
the management microcontroller being electronically connected to the wide-area wireless transceiver and the personal-area wireless transceiver;
the attachment microcontroller, the at least one hit-detection sensor, and the attachment wireless transceiver being mounted within the attachment housing;
the plurality of notification lights being externally mounted to the attachment housing;
the attachment microcontroller being electronically connected to the at least one hit-detection sensor, the attachment wireless transceiver, and the plurality of notification lights; and
the wide-area wireless transceiver being communicably coupled to the attachment wireless transceiver for each of the plurality of target-attachment units.

2. The live-fire training system as claimed in claim 1 comprises:
at least one portable computing device;
the at least one portable computing device comprises a portable wireless transceiver; and
the personal-area wireless transceiver being communicably coupled to the portable wireless transceiver.

3. The live-fire training system as claimed in claim 1 comprises:
each of the plurality of target-attachment units further comprises a unit-attaching mechanism; and
the unit-attaching mechanism being externally mounted into the housing.

4. The live-fire training system as claimed in claim 2 comprises:
the unit-attaching mechanism comprises a plurality of magnets and a plurality of magnet cavities;
the plurality of magnet cavities traversing into the attachment housing; and
each of the plurality of magnets being mounted into a corresponding cavity from the plurality of magnet cavities.

5. The live-fire training system as claimed in claim 1 comprises:
the attachment wireless transceiver being a long range wide area network (LoRaWAN) module.

6. The live-fire training system as claimed in claim 1 comprises:
the wide-area wireless transceiver being a LoRaWAN module.

7. The live-fire training system as claimed in claim 1 comprises:
the at least one hit-detection sensor being an accelerometer.

8. The live-fire training system as claimed in claim 1 comprises:
each of the plurality of notification lights being a red-green-blue light emitting diode (RBG LED) module.

9. The live-fire training system as claimed in claim 1 comprises:
each of the plurality of notification lights being an infrared light emitting diode (IR LED) module.

10. The live-fire training system as claimed in claim 1 comprises:
each of the plurality of target-attachment units further comprises a plurality of light cables and a plurality of light-attaching mechanisms;
each of the plurality of notification lights being electronically connected to the attachment microcontroller by a corresponding cable from the plurality of light cables; and
each of the plurality of light-attaching mechanisms being externally mounted into a corresponding light from the plurality of notification lights.

11. The live-fire training system as claimed in claim 10 comprises:
each of the plurality of target-attachment units further comprises a plurality of electronic ports;
each of the plurality of light cables comprises a distal cable end and a proximal cable end;
each of the plurality of notification lights being electronically connected to the fixed cable end of the corresponding cable;
the plurality of electronic ports being integrated into the attachment housing;
the plurality of electronic ports being distributed about the attachment housing;
the plurality of electronic ports being electronically connected to the attachment microcontroller; and
the free cable end for each of the plurality of light cables being electronically engaged to a corresponding port from the plurality of electronic ports.

12. The live-fire training system as claimed in claim 1 comprises:
each of the plurality of target-attachment units further comprises an attachment portable power supply;
the attachment portable power supply being mounted within the attachment housing; and
the attachment portable power supply being electrically connected to the attachment microcontroller, the at least one hit-detection sensor, the attachment wireless transceiver, and each of the plurality of notification lights.

13. The live-fire training system as claimed in claim 1 comprises:
the at least one remote management unit further comprises a management portable power supply;
the management portable power supply being mounted within the management housing; and
the management portable power supply being electrically connected to the management microcontroller, the wide-area wireless transceiver, and the personal-area wireless transceiver.
